(19) United States
(12) Patent Application Publication
(10) Pub. No.: US 2007/0086632 A1
(43) Pub. Date: Apr. 19, 2007

(54) Medical data storage or review with interactive features of a video format

(75) Inventors: Sankaralingam Ramraj, Sunnyvale, CA (US); Aaron Schuman, Mountain View, CA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc.

(21) Appl. No.: 11/387,950

(22) Filed: Mar. 22, 2006

Related U.S. Application Data
(60) Provisional application No. 60/723,085, filed on Sep. 30, 2005.

(51) Int. Cl. G06K 9/00

(52) U.S. Cl. 382/128

(57) ABSTRACT

Storage and/or review of medical data are provided with interactive features of a video format. One or more examinations are stored in a DVD format. Using a standard format, standard equipment may be used to view the stored examinations. Interactive features of the video format allow navigation. Chapter selection allows choices of different examinations, patients or other information on the media. Parental controls are used to protect confidentiality. Measurements are available through selection of an overlay menu. Different views, renderings, annotations, measurements or other medical information are available by selecting of different recordings of the examination or image. Separate programs may not be needed to view the data. Other data may be stored in other formats for use by separate programs, such as storing DICOM information on a same media.

### RELATED APPLICATIONS

The present patent document claims the benefit of the filing date pursuant to 35 U.S.C. §119(e) of Provisional U.S. Patent Application Ser. No. 60/723,085, filed Sep. 30, 2005, which is hereby incorporated by reference.

### BACKGROUND

The present embodiments relate to medical data storage with interactive features of a video format.

Digital Versatile Disk (DVD) media is a high-density storage media. New medical imaging systems may allow the customer to copy medical records and images to DVD media. If the medical records or images are stored on a DVD using the DVD-ROM format, the medical records or images are saved in a computer accessible and editable format. The user may mount the disk as a file system on a computer and, using appropriate applications, may perform a wide variety of actions such as file system navigation, search, rendering, or performing measurements. If medical records or images are stored on a DVD using the DVD-video format, the user does not need a computer to access the medical documents. The user may use a common DVD player. However, the user's actions may be significantly restricted, such as the user may only select particular examinations indexed as chapters. No editing or further image processing is provided.

### BRIEF SUMMARY

By way of introduction, the preferred embodiments described below include methods, systems, and computer readable media for storage and/or review of medical data with interactive features of a video format. One or more examinations are stored in a video format, such as the DVD format. Using a standard format, standard non-computer equipment may be used to view the stored examinations. Interactive features of the video format allow navigation by the user. For example, chapter selection allows choices of different examinations, patients or other information on the media. As another example, parental controls are used to protect confidentiality. In another example, measurements are available through selection of an overlay menu. Different views, renderings, annotations, measurements or other medical information are available by selecting of different recordings of the examination or image which may create the impression of further editing or image processing.

Standard or data based video instructions are stored with the medical data for generating displays. Separate programs may not be needed to view the data. Other data may be stored in other formats for use by separate programs, such as storing DICOM information on a same media.

In a first aspect, a computer readable storage medium has stored therein data representing instructions executable by a programmed processor for review of medical data with interactive features of a video format. The instructions are for: displaying the medical data in a DVD-video format, and navigating the displaying in response to user input other than chapter selection.

In a second aspect, a system is provided for review of medical data with interactive features of a video format. A DVD player has a processor responsive to standard interaction features corresponding to a DVD-video format and has a user input operable to receive user commands corresponding to the standard interaction features. A DVD disk has medical data in the DVD-video format. The medical data includes first and second alternatives for a same image. The DVD player is operable to output video as a function of the medical data and the user commands. At least one of the user commands is operable to select between the first and second alternatives.

In a third aspect, a method is provided for review of medical data with interactive features of a video format. A sequence of medical images is generated for a first medical imaging examination pursuant to a DVD-video format. Control of the generating is provided by user selection of a DVD-video format feature.

In a fourth aspect, a computer readable storage medium has stored therein data representing instructions executable by a programmed processor for review of medical data with interactive features of a video format. The instructions are for: displaying a first sub-set of the medical data in a DVD-video format, and displaying a second sub-set of the medical data in a DICOM format, the second sub-set different from the first sub-set.

In a fifth aspect, a method is provided for storage of medical data with interactive features of a video format. A processor stores a first sub-set of the medical data as DVD-video data. The processor also stores a second sub-set of the medical data as DICOM data. The second sub-set is different than the first sub-set.

The present invention is defined by the following claims, and nothing in this section should be taken as a limitation on those claims. Further aspects and advantages of the invention are discussed below in conjunction with the preferred embodiments.

### BRIEF DESCRIPTION OF THE DRAWINGS

The components and the figures are not necessarily to scale, emphasis instead being placed upon illustrating the principles of the invention. Moreover, in the figures, like reference numerals designate corresponding parts throughout the different views.

FIG. 1 is a block diagram of one embodiment of a system for storage and review of medical data with interactive features of a video format;

FIG. 2 is a flow chart diagram of one embodiment of a method for review of medical data with interactive features of a video format; and

FIGS. 3-5 are graphical representations of a video format in one embodiment;

FIGS. 6-9 are graphical representations of different embodiments of menu structures in a standardized video format; and

FIG. 10 is a flow chart diagram of one embodiment of a method for storage of medical data with interactive features of a video format.

### DETAILED DESCRIPTION OF THE DRAWINGS AND PRESENTLY PREFERRED EMBODIMENTS

Medical data is stored in a DVD-video format for an integrated explorer and review application. The interactivity features of DVD-Video specification provide review and allow exploration without requiring separate application software. There is no need for a computer to explore and review the records on the DVD media. A cheap or more easily accessible DVD player allows viewing of the medical information. No special user interface manual is required, since playback uses the DVD user input. There are no special directions required for international customers since the DVD-video allows for different languages and conversion units. The instructions for interactivity and playback are incorporated with the medical data and operate pursuant to the DVD-video standard.

To provide DICOM conformance, the medical data is provided on a same media in two different formats. For example, both MPEG-2 and DICOM formats are used. The medical data in the MPEG-2 format plays on the DVD-Player, and the medical data in the DICOM format plays on a DICOM workstation using DICOM application software.

One or more images may represent a screen or interface of another application or a medical system. The menu structure of the DVD-video is used to emulate the interface. Using different images or sequences and corresponding menus, the operation also emulates the interface for reviewing stored data.

Interactive features built into the DVD playback allow for versatile exploration of the stored medical data. For example, patient health information access is limited using parental control or a game control. As another example, voice annotation control for the medical information uses MUTE and channel selection on DVD Player. Different audio annotations are provided. In another example, sub-picture features are used for information about the medical data, such as measurement presentations, or information leading to business (presenting customer messages such as visit www.hospital.com). Measurement controls, such as to display the pre-measured value (by pressing the subtitle), to select submenu with choice to display the measurement report in worksheet form or in a graphic form (by pressing Select), are accomplished using the interactive features.

A DVD-video formatted disk consists of a hierarchical structure, which subsumes video objects (VOB) under video title sets (VTS). The medical data may be auto-indexed on the DVD to be elements within this hierarchy. Menu groupings provide record locations sorted on a property of the medical record. Any one or more properties may be used for the groupings, such as patient name, annotation, clip type, exam type, or measurements. Personal health information (PHI) records are another element. By providing a separate element for PHI, such records may be encrypted or password protected. Applicable settings of medical records, such as language or internalization of units, may be provided. Bookmarks of medical records may be saved. Measurement controls for measurements may be provided. For example, different types of measurements are saved separately for access through menus. Rendering controls, such as cine-playback controls, and zoom-in/zoom-out, may be provided by saving images associated with the different rendering controls. By storing multiple elements associated with a same DVD, examination, image, video, patient or other characteristic, different options are provided for viewing medical information associated with the characteristic.

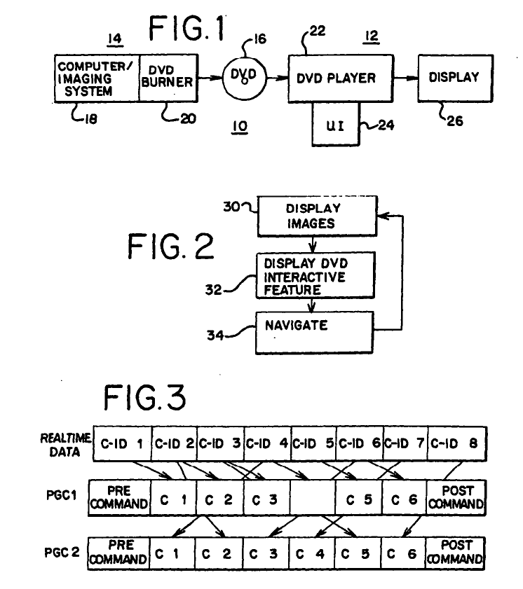

FIG. 1 shows a system 10 for storage and review of medical data with interactive features of a video format. The system 10 includes a storage system 14 with a computer or imaging system 18 and a DVD burner 20. The system 10 also includes a review system 12 with a DVD player 22, a user interface 24 and a display 26. Different, additional or fewer components may be provided in the review system 12 or the storage system 14. The review system 12 may be the storage system 14 or vice versa. For example, the imaging system 18 uses the DVD burner 20 as the DVD player 22 to generate images on the imaging system 18. As another example, the DVD player 22 stores the medical data with a burner capability.

In the embodiments described herein, a DVD-video specification is used as the video format. Other now known or later developed standardized video formats may be used. For example, another video format providing for display and interactivity without requiring separate installation of application software is used.

A DVD disk 16 allows storage and review by the storage or review systems 14, 12. The DVD disk 16 is a read only, writable, erasable or other optical media. Media other than optical, such as magnetic, RAM, ROM or other memories, may be used as the DVD disk 16.

The DVD disk 16 includes medical data in the DVD-video format. The UDF files system with or without ISO9660 for windows compatibility is provided. Other file systems or video formats may be used. The DVD disk 16 is free of processor instructions different that the standard interaction features. Application programs or software is not provided for DVD-video playback. Instructions associated with standard features are provided, but not an entire application. In alternative embodiments, the DVD disk 16 also includes an application program for other uses or to allow editing of the medical data.

The DVD disk 16 includes only DVD-video data. In other embodiments, other medical data is included. For example, medical data is also stored on the DVD disk 16 in a DICOM compatible format. The same or different medical data is stored in both DVD-video and DVD-ROM formats, allowing review of the medical data by a computer or imaging system 18 pursuant to one format and the computer or imaging system 18 or DVD player 22 pursuant to another format.

The medical data includes menus, text, images, sequences, video, audio or other elements in alternative arrangements. Alternative measurements may be obtained and stored. For example, distance measurements associated with different combinations of locations on a same image are obtained and stored. Alternative annotations may be obtained and stored. For example, images or sequences without and with written and/or audio annotations are obtained and stored. As another example, annotations from different sources, such as different medical professionals, are obtained and stored separately or in combination. Alternative renderings may be obtained and stored. Views of a same region from different directions, different zoom levels, different two or three-dimensional rendering settings, different acquisition settings and/or different image processing settings are obtained and stored. Medical data for alternative CINE playback sequences, speeds, lengths, frame rates, or other CINE settings may be obtained and stored. Combinations of these or other alternative imaging or processing may be used. Alternatives include with or without an element or feature and/or with different settings of an element or feature. Obtaining and storing different alternatives allows for viewing options for the medical data. In alternative embodiments, the medical data includes only one version of one or more features or elements.

The computer or imaging system 18 is a medical diagnostic imaging system, an ultrasound system, a workstation, a PACS workstation, a personal computer or other now known or later developed system for processing data. For example, the computer or imaging system 18 is a computer used by a service for storing examination information or other medical records on the DVD disk 16. As another example, the computer or imaging system 18 is a diagnostic or therapeutic imaging system which stores the examination on the DVD disk 16 for use by the patient, archiving or for other medical professionals. The computer or imaging system 18 obtains the medical data by scanning or receiving from any source, such as a memory, removable media or over a network.

The DVD burner 20 includes a laser or other device for creating read only, writable or erasable DVD disks 16. Any now known or later developed DVD burner 20 may be used. In other embodiments, the DVD burner 20 stores DVD-video medical data on other media, such as RAM or CD.

The DVD player 22 is a computer, an imaging system, a stand-alone DVD player, or other now known or later developed device for generating video and/or audio from data pursuant to the DVD-video format. The DVD player 22 connects with a separate display 26 or integrates the display 26. The user interface 24 is a remote control, DVD player control panel, a touch screen, a keyboard, or other user input device for interacting with displayed information or for providing standard interaction features.

The DVD player 22 includes a processor responsive to standard interaction features corresponding to the DVD-video format. The processor is a digital signal processor, application specific integrated circuit, a field programmable gate array, a general processor, a digital circuit, an analog circuit, combinations thereof, or other now known or later developed processing device. The DVD-video specification provides a simple programming language for interactivity. Program chains (PGCs) provide interactivity using simple program commands. The DVD player 22 generates video and audio according to the predefined program chains. Program chains define menu hotspots, and link hotspots to particular actions and to play video sequences. Program chains may also add conditional branching and other programming features (e.g., DVD game playing or password entry) for more complex interactive applications. The processor is responsive to the programming chains pursuant to the DVD-video format.

The DVD-video format provides for a DVD menu interface including standard controls. The standard controls allow interactive features, such as: selection of an study or examination where more than one is on the DVD disk 16, selection of images by number or skipping to the next or previous chapter, book marking clips for later access, fast and slow forward and reverse controls for rendering 2-D, 3-D or 4-D images, angle selection giving the user the choice of different views of 3-D or 4-D images, parental control for blocking PHI from display, measurement selection, picture aspect ratio, language or others.

The user interface 24, such as a remote control, may include a number of standard buttons for controlling the DVD player 22. The standard inputs include: (a) 0 to 9 used for entering image number or other menu selections, (b) TITLE/MENU to display the explorer on-screen menu from the DVD disk 16, (c) Up, Down, Left, Right, Select menu buttons to select from menus and/or control 3-D or 4-D rendering, (d) Play, Pause, Skip, Stop to control playing of video, (e) Fast reverse, forward to play image frames in forward or reverse direction at faster than normal speed, (f) Slow reverse, forward to play image frames in forward or reverse direction at slower than normal speed, (g) Subtitle to switch on/off and select measurements or other options to be displayed, (h) Audio to select an audio stream, such as for different voice annotations, (i) Angle to select 2-D or 3-D viewing directions, and/or (j) Set-up to set player parameters, such as language, audio and display aspect ratio (normal or widescreen). The controls listed above may be used for additional or alternative functions. Additional, different or fewer controls for controlling the same or different functions may be provided. The functions associated with a control are related to the usual use of the control for DVD viewing, but may be associated with different medical image features.

The DVD player 22 is operable to output video as a function of the medical data and the user commands. For example, the DVD-player 22 automatically or in response to user pressing a menu button displays a menu. The user selects an examination from a menu listing of available examinations by patient, date, examination type, annotations, or other criteria. The associated examination is then displayed as a sequence of images. The speed of playback, angle of viewing, audio track and/or other information is controlled during the playback. Submenu or displayed menu overlays may also allow branching to other displays during the playback. The user interaction to select different options allows at least one of the user commands to select between the first and second alternatives. The alternatives may be associated with different settings, renderings, arrangements or other feature for viewing the same images, or may be associated with different examinations or images.

Since DVD-video playback and interactive exploring are used, the DVD disk 16 and the processor of the DVD player 22 may be free of processor instructions different that the standard interaction features for playback. Extra applications are not needed. A user may view and control viewing of the medical data on a standard video player.

The DVD disk 16 includes the medical data. Using the DVD-video format, the medical data includes instructions used by the processor of the DVD player 22. The instructions correspond to interactivity and playback features incorporated into the DVD-video specification. The DVD player 22 also includes computer readable media other than the DVD disk 16 with instructions for controlling the processor. The instructions implement the DVD-video specification. In response to user input and instructions on the DVD disk 16, the processor uses the instructions on the DVD player 22 generate a display.

The DVD disk 16 and/or media in the DVD player 22 are computer readable storage media having stored therein data representing instructions executable by the programmed processor for review of medical data with interactive features of a video format. Similarly, the computer or imaging system 18 includes storage media with instructions for storing the medical data pursuant to the DVD-video format. The instructions implement the processes, methods and/or techniques discussed herein. The instructions may be transferred to or from other computer readable media, such as a cache, buffer, RAM, removable media, hard drive or other computer readable storage media. Computer readable storage media include various types of volatile and nonvolatile storage media. The functions, acts or tasks illustrated in the figures or described herein are executed in response to one or more sets of instructions stored in or on computer readable storage media. The functions, acts or tasks are independent of the particular type of instructions set, storage media, processor or processing strategy and may be performed by software, hardware, integrated circuits, filmware, micro code and the like, operating alone or in combination. Likewise, processing strategies may include multiprocessing, multitasking, parallel processing and the like. In one embodiment, the instructions are stored on a removable media device for reading by local or remote systems. In other embodiments, the instructions are stored in a remote location for transfer through a computer network or over telephone lines. In yet other embodiments, the instructions are stored within a given computer, CPU, GPU or system.

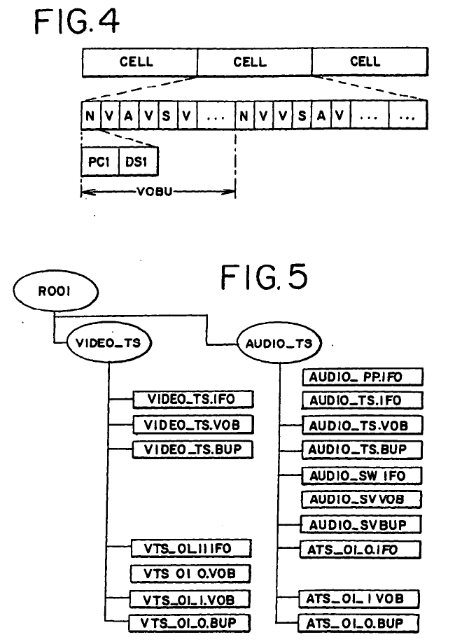

FIG. 2 shows a method for review of medical data with interactive features of a video format. Additional, different or fewer acts may be provided. For example, images are displayed in act 30 and interactive features are used to navigate in act 34 without display in act 32. One example is using angle control to alter viewing direction for 3-D representations. The user uses the angle control features on the remote control or input device without there being a display of the availability of the feature. The method is implemented by the system 10, the review system 12, or the storage system 14 of FIG. 1, but a different system may be used.

Medical data is transferred for generating a display. The transfer is from or onto a DVD disk, but may be provided by other transfers. The medical data has a DVD-video format.

In act 30, one or more medical images are generated from the medical data. For example, a sequence of medical images is generated for a particular medical imaging examination. The images are generated and displayed pursuant to the DVD-video format. DVD-video playback of the MPEG-2 formatted medical data generates the images.

Other medical data may have a different format, such as the DVD disk including medical data formatted in a Digital Imaging and Communications in Medicine (DICOM) format. One sub-set of the medical data is in a DVD-video format, but another sub-set of the medical data in a DICOM format may be displayed using other applications. The different sub-sets may represent the same or different images or examinations. For example, medical data in the DICOM format includes one, a fewer number, a same number or more versions of an examination while medical data in the DVD-video format includes one or multiple versions of the examination, each version associated with different settings or possible user selections.

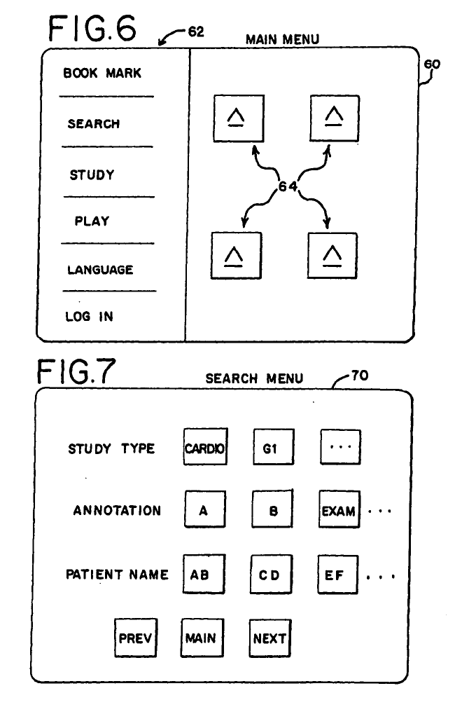

In the DVD-video format, a cell is a unit of playback of real-time image data. Each cell is identified with a fixed ID number. A PGC defmes the order in which cells are played. FIG. 3 shows this structure. Different cells may be linked to one or multiple PGCs. Each PGC defines the order in which the cell numbers are played. A study, organized as a title in the DVD-video format, is comprised of one or more linked PGCs. For example, a CINE playback may be provided as one title of one PGC. The cells recorded on the DVD disk are played back in order based on the cell numbers. If multiple titles, such as multiple examinations for teaching studies, with different sequences in a study set are defined by their own PGCs, then each PGC calls out the cells to be played for that title and the order in which they are to be played. Each cell of a PCG references a cell identification number. One or more images or other elements correspond to each cell identification number. Different examinations and/or a same examination with different images or menus are provided as different titles or branches of PGCs.

Each PGC may also contain a pre-command, such as selection of speed to play or stopping until receiving input, which is executed before playing the first cell. Each PGC may also contain a post-command, such as selection of reverse play back, which is executed after playing the last cell. The PGC may contain button or cell commands which can be executed each time a cell is played. Through these commands and user operation, one PGC can branch into multiple PGCs, multiple PGCs can branch into the same PGC, or other linking is provided. Many types of interactive playback may be provided by interlinking the PGCs. For example, a first PGC for an examination begins. If a cell command is received for linking to images associated with a distance measurement, at least one subsequent image from a linked PGC includes the distance measurement. If the user command is not received, the playback continues with the original PGC. The images displayed in either PGC are from different cells (one with the measurement overlaid and one without), but of the same underlying medical image.

Each cell includes one or more video object units (VOBU). FIG. 4 shows one representation of a cell. Each VOBU consists of 0.4 seconds to 1 second of playback time of medical data images. Each VOBU begins with a navigation pack (NV_PCK) and is followed by several groups of pictures (GOP) structures which contain video, audio, sub-picture, and other data in a packetized, time-division multiplexed fashion. However, a VOBU is not required to contain any data other than the NV_PCK.

The NV_PCK is comprised of two packets, called presentation control information (PCI) and data search information (DSI). In order for DVD players to support variable-rate playback and seamless playback, a memory, called a track buffer, is positioned between the pickup and the decoder. There is a time delay between the signal being read by the pickup and the video and audio being decoded and played. Real-time control information is divided between and stored within the PCI and DSI packets, and the player checks and utilizes this information after and before the cell passes through the track buffer.

The content within a VOBU may be shorter than the playback time of the VOBU itself (e.g., such as for providing slow motion without user selection of a slow playback). Further, the number of frames per GOP is not fixed. If the GOP ends with an MPEG sequence end code, playback will be paused on the last frame of the GOP. Still frames may be displayed for an arbitrary length of time at arbitrary points within video playback. Such still images may be used for a medical image or for an image used for a menu. Audio information may also be added to such sequences.

The data or image file is resized depending on the aspect ratio of the final product as well as the screen format (NTSC or PAL). This will be 16×9 (anemographic wide screen) or 4×3 (standard full-screen). NTSC16×9 ratio final file is resized from 960p×540p to 720p×480p. NTSC 4×3 ratio final file is first cropped from 960p×540p to 720p×540p, and then resized to 720p×480p. PAL 16×9 ratio final file is resized from 960p×540p to 720p×576p. PAL 4×3 ratio final file is first cropped from 960p×540p to 720p×540p, and then resized to 720p×576p. The final files are delivered in either 16×9 or 4×3 ratios, but other ratios may be used in other formats. The title creator can specify either “pan & scan” (cutting off a portion of the image) or “letterbox” (showing then entire image with black bands at the top and bottom of the screen) format to provide output of 16:9 aspect ratio video content at an aspect ratio of 4:3.

The files used for video and audio are arranged in directories called VIDEO_TS and AUDIO_TS, respectively. FIG. 5 shows one example. The files in these directories have predetermined names and extensions. Files with the extension “.IFO” contain application information (e.g., menu structure or PGCs) to reproduce the content. For each “.IFO” file there is a back-up file with the same name but the “.BUP” extension. Files with the “.VOB” extension contain the actual video or audio content (e.g., cells).

The files are provided as presentation data for generating images. Within the presentation data, video, audio, and sub-picture data are multiplexed with a portion of the navigation data in conformance with the MPEG-2 program stream specification. The structure of the data complies with this specification, and each pack contains 2048 bytes. The multiplex rate (mux_rate) is 10.08 Mbps.

Table 1 provides video specifications for the DVD-video format.

TABLE 1

| | |
|---|---|
| Data compression | MPEG2, MPEG1 |
| Bit rate | 9.8 Mbps max. (MPEG-2) |
| | 1.856 Mbps max. (MPEG-1) |
| GOP size | 36 fields max. |
| Screen display | |
| TV systems | 525/60, 625/50 |
| Aspect ratios | 4:3, 16:9 |
| Modes | Pan & scan, Letterbox |
| User data | closed captions (Help, Any |
| | information) |

Video data exists as one stream of data compressed according to the MPEG-2 video format. The maximum bit rate is 9.8 Mbps, and the stream supports variable bit rate to provide high-quality video.

Table 2 provides audio specifications for the DVD-video format.

TABLE 2

| | Linear PCM | Dolby Digital | MPEG Audio |
|---|---|---|---|
| Fs | 48 kHz, 96 kHz | 48 kHz | 48 kHz |
| Qb | 16/20/24 bits | Compressed | Compressed |
| Bit-rate | MAX 6.144 Mbps | MAX 448 kbps | MAX 912 kbps |
| (per 1stream) | | | |

Three audio formats are allowed by the DVD specification: linear PCM, Dolby Digital, and MPEG audio. Each title can have up to eight audio streams. The streams are distinguished by attributes such as language. For audio annotation, different annotations may be provided in different channels or streams for the same image or sequence. For audio Doppler or other medical scan audio information, the audio corresponds to different settings (e.g., no audio Doppler vs. audio Doppler or audio Doppler with one scan or processing setting vs. audio Doppler with another scan or processing setting). Each stream is comprised of multiple channels. For instance, the Dolby Digital format supports 5.1 channels. When using the linear PCM format, DVD audio can support a sampling rate of up to 96 kHz with up to 24 bits per sample, providing audio quality, which far surpasses that of CDs. For Dolby Digital or MPEG audio, the sampling rate is 48 kHz. MPEG audio supports MPEG-2 audio with multi-channel capability.

Table 3 provides sub-picture specifications for the DVD-video format.

TABLE 3

| | |
|---|---|
| data format | run-length encoding, two bits per pixel |
| data size per picture | 52 kB max. |
| resolution | 720 × 480 (525/60) |
| | 720 × 576 (625/50) |
| display color | 16 colors (specified per PGC) |
| display control | change pixel contrast and color |
| | change display area (move) |
| | change display data (scroll up/down) |
| | force display |

Sub-picture data includes measurements, reports, or other defined information which is overlaid as a bitmap onto the main video content. This data is compressed using run-length encoding. Up to 32 streams of sub-picture data can exist for each title. Sub-picture streams are distinguished by attributes such as language. Sub-picture data can be displayed in up to 16 different colors. For applications such as subtitles, the user controls the display of sub-picture data. The DVD-video format also supports the forcing of sub-picture data display. For example if the medical data contains PHI, a menu or dialog is displayed at a particular point in the content stream to require the user to enter a password. As another example, a menu associated with different options related to an image or sequence is provided as sub-picture data. Different measurements are provided for selection during display of the image or sequence. Alternatively, a menu based on .ifo files or other control feature is provided.

The DVD-video format is described above. The DVD-video format may be altered or have different values. Alternatively, a different DVD format provided. Other video formats may be used. Other data types, data divisions or structures may be used.

Referring again to FIG. 2, a DVD interactive feature is displayed in act 32. The interactive feature is displayed as text or a graphic. The interactive feature may provide a menu of one or more options. The interactive feature is on an independent screen or overlaid on an image, such as sub-picture information. In alternative or additional embodiments, one or more interactive features are not displayed. For example, some features correspond to possible user inputs. The user is aware of the features without a corresponding display. In one embodiment, adjusting a viewing angle, fast forwarding, or reversing is provided in response to a user depressing a switch or button without showing the option on the display. Alternatively, the display may include a selectable feature or a text reminder of possible use of these features.

Each interactivity feature is associated with a DVD-video format control feature. For example, the features correspond to audio channel selection, cell button control, PGC pre or post chain control, combinations thereof, or other now known or later developed control features of the video format.

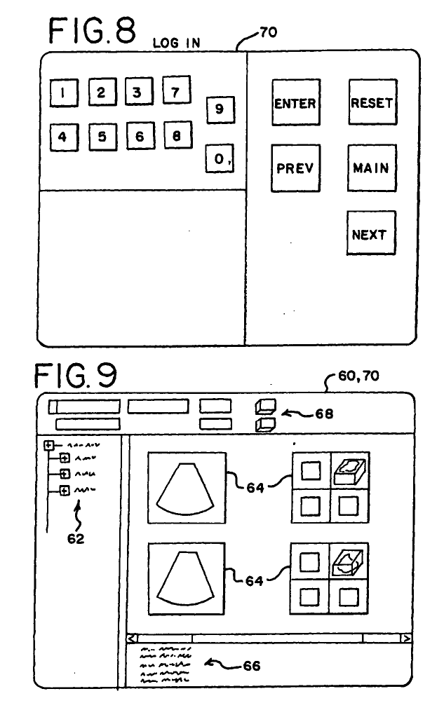

FIGS. 6-8 show different menus or sub-menus incorporating interactivity features. FIG. 6 shows a menu 60 displayed as an entire screen. Sub-picture menus may alternatively be used. The menu 60 includes selectable, highlightable, or reference textual options 62. For example, the text is highlighted when the user navigates to the text. As another example, a button or object next to the text appears, highlights, moves, or changes based on user navigation. The user may select the textual option 62. Textual options 62 include search, study (examination), play, language, login, book mark, combinations thereof or other options.

The menu 60 also includes graphical icons 64. The graphical icons 64 represent a function, such as searching, fast forwarding or others, or show images or video associated with a selectable option. For example, each of the graphical icons 64 is a different image of a sequence or examination available on the DVD.

FIG. 7 shows a sub-menu 70. In particular, a search menu is shown. In response to selection of the “search” textual option 62 in FIG. 6, the search sub-menu 70 is displayed by the DVD player. Other textual options 62 or graphical icons 64 are provided in the search menu. For example, some predefined search categories associated with a particular DVD or medical data in general are provided. As another example, an alphabet and/or numbers are shown for selecting. The user may spell out a search word and/or select a number for searching. Selection of an option may lead to further options or other medical data linked to the selection.

FIG. 8 shows a sub-menu 70. In particular, a login sub-menu 70 is shown. Using parental or game control features, textual options 62 and/or graphical icons 64 are displayed. The user enters a password, number, or combination to access patient health information. Without the password, generic examinations, examinations without patient references only, a sub-set of examinations, or no examinations are available to the user.

FIG. 9 shows another embodiment of a menu 60 or sub-menu 70. The embodiment is described as a menu 60 below. The menu 60 is modeled after or resembles a user interface or review page of a medical imaging system. For example, the menu 60 is made to be identical to at least one screen of an imaging system. FIG. 9 shows the screen as a Windows® type Explorer layout, but other layouts, screens or user interfaces may be used. For example, the menu 60 resembles a user-interface of the SYNGO patient browser with an Explorer interface.

The menu 60 includes or does not include medical information. The medical information may be diagnoses, text, audio or images. In the example of FIG. 9, graphical icons 64 include two-dimensional images or planar reconstructions, or three-dimensional renderings associated with different scans or examinations. Alternatively, the menu 60 is devoid of patient health care information or even medical information. The graphical icons 64 are highlightable or selectable. The textual options 62 correspond to patient names, examination names, or other lists organized as desired. For example, selection of one textual option 62 may result in the menu 60 displayed again, but with different textual options 62 and/or graphical icons 64 based on the selected option. Drop down menus or button controls 68 may also be provided for user interaction. A summary, text or graphic 66 associated with a currently highlighted and not selected or selected icon 64 or option 62 may be displayed.

In one embodiment, all of the options associated with the modeled user interface are available in the menu 60. The medical data is stored on the DVD in a way to emulate the possible selections. PGC or other format controls are used to react to user selections. Alternatively, one or more features available in the emulated user interface are displayed but not usable or not provided on the display.

DVD interactive features may be displayed in other ways as well. For example, at least some of the medical data or other options (graphical or textual) are displayed as a sub-picture overlaid on at least one medical image or video. The medical data may include measurements, diagnoses, or other medical related selectable options. For example, length, volume, Doppler gate placement, or other measurements with or without results are provided as selectable options in a sub-picture. In response to selection, information associated with the selected option is displayed either in a subsequent image or screen or as a sub-picture overlay. The sub-picture information may be additionally or alternatively used to display medical information associated with an image or sequence, such as patient name, imaging parameters and/or measurement results.

Referring again to FIG. 2, control of the generation of the display is provided by user selection of an interactive feature in act 34. The selected feature is a displayed or non-displayed feature. The user navigates the displaying with user input. The exploring is performed pursuant to DVD-video format interactivity. For example, the user selects one of multiple examinations with a chapter selection of the DVD-video format. As another example, patients, annotations, study type (e.g., cardio, abdominal, breast or others), or other divisions of information are provided through chapter or title selection interactivity features. Other features than chapter selection may be used for navigating, while also providing or not providing for chapter selection features. For example, parental control, sub-picture or other features allow navigation of available medical information.

In one embodiment, access to personal health information is limited pursuant to a parental control feature of the DVD-video format. The user is unable to view all or some of the medical information until a user password, number sequence, key combination or combinations thereof are input by user interaction in act 34. The interface or menu prompts the user for an authentication key.

In one embodiment, the user selects a graphic icon. A PGC begins based on the selection of a graphic icon. Different PGCs are used for different selections. For example, a plurality of medical images associated with different examinations or scans are displayed on a screen. By selecting one of the medical image graphical icons, the PGC associated with the selected examination starts.

In one embodiment, voice annotation is controlled interactively using mute and channel selection features of the DVD-video format. Mute turns on or off voice annotation. Alternatively, one or more selections are associated with no voice annotation. Channel selection allows different audio annotations to be provided and interactively controlled before or during playback of an image or examination.

In one embodiment, different medical imaging alternatives are selected interactively. One alternative may be the lack of a value or setting. Other alternatives include different measurements, annotations, renderings or combinations thereof. Different PGC, cells, sub-pictures or other DVD-video format items are provided for the different alternatives. For example, a same base image or sequence of images is provided for each alternative. Additional information is provided or not provided based on the selected alternative. Where a measurement is available, the sequence will display without the measurement as one alternative. If the user selects the measurement, all or a portion of the same base image or sequence is displayed with the measurement location and value markings or text. The measurement information is provided as a stored image or a sub-picture. As another example, different possible renderings of a same volume or different image processing of a same scan are stored. Selection of alternatives determines which rendering and/or image of the same examination are displayed.

Other interactive features associated with medical data or generating any display may be provided. All, some or none of the features discussed above may be used by the user or provided to the user.

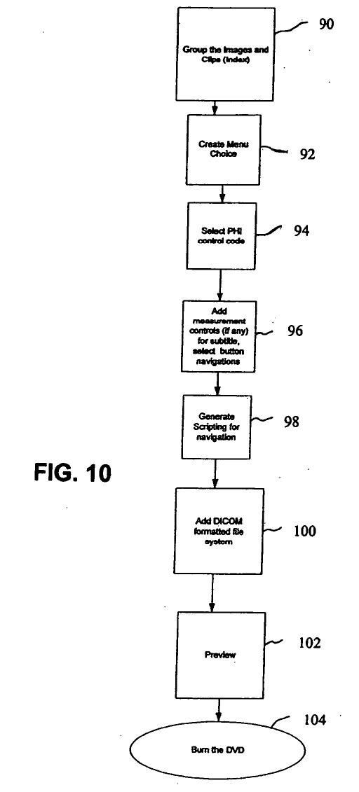

FIG. 10 shows a method for storage of medical data with interactive features of a video format. The method formats the medical data for storage pursuant to the DVD-video format. Additional, different or fewer acts may be provided. The method uses the system 10, storage system 14 or review system 12 of FIG. 1, but other systems may be used.

A processor stores the medical data as DVD-video data. All or a sub-set of the acquired medical data is stored. Any now known or later developed DVD-RW software toolkits may be used for storage. Any now known or later developed auto indexing tools may be used for formatting the medical data. For example, Scripting Pack for DVD Studio PRO and/or Authoring SW are used. As another example, the SYNGO patient browser tool may provide some auto-indexing tools. The automatic indexing is then used for formatting pursuant to the DVD-video specification.

In one embodiment, an index file is created for the studies in act 90. The studies are indexed by study type, annotation, measurements, imaging mode, imaging time, patient's name, combinations thereof or other category. Presentation files are created depending on the or for each index file. The navigation controls, such as PCG and menus, are created in act 92. A main menu is added in act 92. The menu includes any of the features discussed herein, such as textual options for patient browser (i.e., selection of different patients), study type, and search. The features of the menu link each item of the grouped images and sequences with a thumbnail generated for preview. The .IFO files and .VOB files are created from the navigation controls and indexed medical information. The DVD file is authored with the country code, PHI control code, and/or other information. The master image or sequence is created and previewed in act 102. The files are then burned to the DVD disk after any editing in act 104. The DVD is authored with the labeling using date recorded.

In another embodiment, the medical data is formatted, at least in part, automatically. Images and sequences of medical data are grouped by patient name, study type, by annotation, and/or other categories. Controls for navigation are scripted in act 98. Within each DVD using a 4:3 menu, the option of using up to 36 buttons is provided. When a button is selected in a menu, the status of a System Register is changed. System Registers, also known as System Parameter Register Memory, or SPRM for short, are a series of machine specific items, such as language or audio type. There are 24 SPRMs. The function of SPRM 8 is to hold the current menu item selected. Each SPRM is a 16-bit register. SPRM 8 however uses only 6 of the 16 bits to identify any of the 36 possible buttons on any 4:3 menu. Table 4 shows an example in the current DVD video format.

TABLE 4

| | bit | | | | | | | | | | | | | | | |
|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 |
| value | 1 | 2 | 4 | 8 | 16 | 32 | 64 | 128 | 256 | 512 | 1024 | 2048 | 4096 | 8192 | 16384 | 32768 |

The first bit location is bit 0, and the final bit location is bit 15, for a total of 16 bits in this register. The last 6 bits, or bits 10, 11, 12, 13, 14, and 15, are the bits used to define any of the 36 possible button values in terms of SPRM values. Bit 10 is the first bit in use and its value is 1024. Button 1 is actually bit 10 on, and all other bits off. Button 1 equals 1024 in terms of the SPRM 8 value. Table 5 shows 10 of the buttons in one example script. The button numbers 1 through 10 are multiples of 1024. Button 1=1024, while Button 2=2048, Button 3=3072, and so on. In the SPRM 8 register, only 4 of 6 bits used to define all 36 buttons are actually used for the first 10 buttons.

TABLE 5

| | | 10 | 11 | 12 | 13 | 14 | 15 |
|---|---|---|---|---|---|---|---|
| | | 1024 | 2048 | 4096 | 8192 | 16384 | 32768 |
| Button 1 | 1024 | 1024 | | | | | |
| Button 2 | 2048 | | 2048 | | | | |
| Button 3 | 3072 | 1024 | 2048 | | | | |
| Button 4 | 4096 | | | 4096 | | | |
| Button 5 | 5120 | 1024 | | 4096 | | | |
| Button 6 | 6144 | | 2048 | 4096 | | | |
| Button 7 | 7168 | 1024 | 2048 | 4096 | | | |
| Button 8 | 8192 | | | | 8192 | | |
| Button 9 | 9216 | 1024 | | | 8192 | | |
| Button 10 | 10240 | | 2048 | | 8192 | | |

The scripting package generates in act 98 the scripts dynamically based on the navigation needed for the medical exam in the DVD, including the login authentication.

For example, in the login screen, 10 buttons are provided to enter the password. The password is selected in act 94. GPRM (General Programming Register memory) is used as a temporary storage during login for use. Scripting for Login is as follows. 1) Set GPRM 2 with the password [mov GPRM2, password]. 2) Set GPRM 0 to 0 [Script command: mov GPRM0, 0]. 3) Get SPRM 8, save it to GRPM 1 [Script command is: mov GPRM 1, SPRM 8]. 4) Divide GPRM by 1024, [Script Command is: div GPRM 1, 1024]. 5) Increment GPRM 0 [Script Command is: add GPRM0, 1]. 6) If the GPRM1 does not match the n'th position of the password, continue step 2. [Script command is: mov GPRM3, GPRM2; div GPRM3, 10; mul GPRM3, 10; mov GPRM4, GPRM2; sub GPRM4, GPRM3; mov GPRM2, GPRM3; Goto 2 if (GPRM1 !=GRPM4)]. 7) If GPRM0 reaches 4 (4 is the password length), jump to submenu for the choices [Goto 9 if (GPROMO=4)]. 8) Continue 3 [Script Command is: Goto 3]. 9) Execute submenu [Script Command is: Goto Submenu code]. Other scripting may be used.

Annotations made on the exams are stored as annotation data. Annotation data is presented using the subtitle selection. As soon as subtitle is pressed, the image composite with annotated value is displayed.

For implementing a search feature, the search is scripted in act 98. 10 numeric and 26 alphabet buttons are added, thus using all 36 buttons available for DVD interaction. The search is limited to one word since no space is possible, but other selections of buttons may be used. The search string is completed by pressing Select. One example script for search is:
1. Set GPRM 0 to 0 [Script command: mov GPRM0, 0]
2. Set GPRM2 to 0 [Script command: mov GPRM2, 0]
3. Get SPRM 1, save it to GPRM 5 [Script command is: mov GPRM 5. SPRM 1]
4. if Select is pressed, search string is complete. [Script command is : Go to 12 if (SPRM1=SELECT)]
5. Get SPRM 8, save it to GRPM 1 [Script command is: mov GPRM 1, SPRM 8]
6. Divide GPRM1 by 1024, [Script Command is: div GPRM 1, 1024]
7. if is greater than 10, it is alphabet; Add 50 (making alphabet A) other wise add 20 (making numerical 0) [Script command is: Goto 8 if (GPRM1>10); add GPRM1 50; Goto 9]
8. Script command is: add GPRM1 20
9. Multiply GPRM2 by 256 (to right shift) [Script command is: mul GPRM2, 256]
10. add GPRM1 to GPRM2 [Script Command is: add GPRM1, GPRM2]
11. Continue: [Script command is: Goto 3]
12. Execute the search select menu

Quiz control or scripting is added for search selections. Images or sequences with patient name or patient health information (PHI) is protected by parental control selection with the control code selection.

Measurement controls, if any, are read by a processor and annotated using a scripting package for navigation in act 96. When an image or sequence is selected through navigation, measurement controls, if any, are programmed to subtitle selection. Measurements made on the exams are stored as measurement data. They are presented using the subtitle and select selection. As soon as subtitle is pressed, the measurement value is displayed on the subtitle space and an image composite of the measurement is displayed on the image space. When select is pressed, a choice of displaying the measurement report or worksheet is displayed. Based on the choice, the measurement report or worksheet is presented.

In another more manual method, studies with images and/or sequences are collected. For example, a customer collects the information. The information is then provided to a service for formatting. The formatted data may be provided to the customer for preview, such as by transferring the data as an emulated DVD. The customer or the service authors or finalizes the DVD with labeling selections.

The collected information is grouped into any category or categories. Any voice or text annotation on each subtitle is performed while pre-viewing the images and sequences. The images and sequences with any annotation are converted to a MPEG-2 stream video. A main menu with selection of grouped items with a customer's choice of having thumb nail and/or animation is created. When an image or sequence is selected through navigation, measurement controls, if any, are programmed to subtitle selection. Quiz control or scripting is added for search selections. Images or sequences with patient name or patient health information (PHI) is protected by parental control selection with the control code selection.

The images and sequences are converted to a MPEG-2 stream video for use on the DVD. If an authored DVD is inserted in a DVD player, the DVD player plays the DVD using the main menu that was created.

In optional act 100, the processor stores all or a sub-set of the medical data as DICOM data. The same or different data is stored in the two different formats. For example, the DICOM format may allow some processing of the data. Accordingly, less medical data associated with alternatives, such as rendering, is stored in the DICOM format. The DICOM data may be used to generate different renderings.

For use on a same DVD disk, duplicate DICOM directory and images on the same file system as the DVD-video data is added to the DVD disk. If the DVD disk is inserted into a workstation and if auto play is set to DICOM viewer, the DICOM formatted directory will be read.

While the invention has been described above by reference to various embodiments, it should be understood that many changes and modifications can be made without departing from the scope of the invention. It is therefore intended that the foregoing detailed description be regarded as illustrative rather than limiting, and that it be understood that it is the following claims, including all equivalents, that are intended to define the spirit and scope of this invention.

I (we) claim:

1. In a computer readable storage medium having stored therein data representing instructions executable by a programmed processor for review of medical data with interactive features of a video format, the storage medium comprising instructions for:
displaying the medical data in a DVD-video format; and
navigating the displaying in response to user input other than chapter selection.

2. The instructions of claim 1 wherein the navigating further comprises navigating in response to user input of a chapter selection.

3. The instructions of claim 1 wherein displaying comprise DVD-video playback and wherein navigating comprises exploring pursuant to DVD-video format interactivity.

4. The instructions of claim 1 wherein navigating comprises limiting access to personal health information pursuant to a parental control of the DVD-video format.

5. The instructions of claim 1 wherein at least some of the medical data is formatted as MPEG-2 in the DVD-video format and formatted as Digital Imaging and Communications in Medicine (DICOM) format.

6. The instructions of claim 1 wherein navigating comprises controlling voice annotation using mute and channel selection features of the DVD-video format.

7. The instructions of claim 1 wherein displaying comprises displaying at least some of the medical data as a sub-picture overlaid on a video.

8. The instructions of claim 1 wherein displaying comprises displaying the medical data in at least one screen resembling a user-interface of a medical imaging system, and wherein navigating comprises selecting a program chain associated with a graphic of the at least one screen.

9. The instructions of claim 1 wherein the medical data includes alternative measurements, alternative annotations, alternative rendering, or combinations thereof, and wherein navigating comprises selecting one of the alternatives.

10. A system for review of medical data with interactive features of a video format, the system comprising:
a DVD player having a processor responsive to standard interaction features corresponding to a DVD-video format and having a user input operable to receive user commands corresponding to the standard interaction features; and
a DVD disk having medical data in the DVD-video format, the medical data including first and second alternatives for a same image;
wherein the DVD player is operable to output video as a function of the medical data and the user commands, at least one of the user commands operable to select between the first and second alternatives.

11. The system of claim 10 wherein the DVD disk and processor are free of processor instructions different that the standard interaction features.

12. The system of claim 10 wherein the first and second alternatives comprise alternative measurements, alternative annotations, alternative rendering, alternative zoom levels, alternative CINE playbacks or combinations thereof.

13. The system of claim 10 wherein the medical data further comprises DICOM formatted data.

14. A method for review of medical data with interactive features of a video format, the method comprising:
generating a sequence of medical images for a first medical imaging examination pursuant to a DVD-video format; and
providing control of the generating by user selection of a DVD-video format feature.

15. The method of claim 14 wherein providing control comprises navigating in response to user input of a chapter selection.

16. The method of claim 14 wherein providing control comprises limiting access to personal health information pursuant to a parental control feature.

17. The method of claim 14 wherein providing control comprises controlling voice annotation using mute and channel selection features of the DVD-video format.

18. The method of claim 14 wherein generating comprises displaying at least some of the medical data as a sub-picture overlaid on at least on of the medical images.

19. The method of claim 14 wherein at least one of the medical images resembles a user-interface of a medical imaging system, and wherein providing control comprises providing for selection of a program chain associated with a graphic of the at least one of the medical images.

20. The method of claim 14 wherein providing the control comprises responding to selection of one or more alternative measurements, alternative annotations, alternative rendering, or combinations thereof, and wherein generating comprises generating as a function of the selected alternative.

21. In a computer readable storage medium having stored therein data representing instructions executable by a programmed processor for review of medical data with interactive features of a video format, the storage medium comprising instructions for:
displaying a first sub-set of the medical data in a DVD-video format; and
displaying a second sub-set of the medical data in a DICOM format, the second sub-set different than the first sub-set.

22. A method for storage of medical data with interactive features of a video format, the method comprising:
storing with a processor a first sub-set of the medical data as DVD-video data; and
storing with the processor a second sub-set of the medical data as DICOM data, the second sub-set different than the first sub-set.
